(19) United States
(12) Patent Application Publication
(10) Pub. No.: US 2010/0228682 A1
(43) Pub. Date: Sep. 9, 2010

(54) Project Simulation Method and System

(75) Inventors: Yuichi IKEDA, Mito (JP); Shingo Miyazaki, Tokyo (JP); Takeshi Yokota, Hitachi (JP); Kenji Hatsuda, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/709,281

(22) Filed: Feb. 19, 2010

(30) Foreign Application Priority Data
Mar. 9, 2009 (JP) 2009-054718

(51) Int. Cl. G06Q 10/00; G06N 5/02

(52) U.S. Cl. 705/348; 706/52

(57) ABSTRACT

A simulation for an efficient allocation of the resources, such as funds and manpower, can be performed in plural concurrent projects in order to minimize a delay period and excess of cost. The simulation is practiced with each project regarded as an agent and the optimized solution is outputted by using a genetic algorithm. Specifically, a risk factor of each project is inputted by input means, and the optimal allocation of facilities and labor is determined by arithmetic means with a delay period and a delay event probability using a delay risk model, time development of production, and minimization of an objective function.

### CLAIM OF PRIORITY

The present application claims priority from Japanese Patent Application JP 2009-054718 filed on Mar. 9, 2009, the content of which is hereby incorporated by reference into this application.

### FIELD OF THE INVENTION

The present invention relates to a project simulation method and a project simulation system for simulating an allocation of resources such as funds and manpower, with the aim of minimizing a delay period and excess of cost in project portfolios, such as software development and plant construction.

### BACKGROUND OF THE INVENTION

Many companies constantly possess plural projects (project portfolios). When a risk event such as a delay of a plan arises in individual project, the project manager is forced to work on a countermeasure in view of a balance with the other projects at present. However, since resources of a company, such as funds and manpower, have an upper limit, it is difficult even for an experienced project manager to manage the project portfolio, considering the attribute of the individual project.

As for conventional management technology of a project, “Modeling Complex Projects” by Terry Williams (published by John Wiley & Sons, 2002) systematically introduces a concept and examples in examining risk events, such as a delay in project management. An example of an agent model which applies a game theory based on Econophysics and is intended for a company is introduced in the Chapter 7 of “Econophysics” by Hideaki Aoyama, Hiroshi Iyetomi, Yuichi Ikeda, Wataru Soma, and Yoshihisa Fujiwara (published by Kyoritsu Shuppan, 2008).

Conventional project management technology is associated with an individual project, and it is considered that a management system with respect to a project portfolio for the entire projects is virtually non-existent.

Conventional project management system possesses a function to set up a risk event in an individual project and to display influence on cost etc.; however, it does not possess a function to output an optimized solution of a resource allocation considering the balance with the other projects.

Finding an optimized solution requires a huge amount of calculation in many cases; therefore, the conventional project management system is not suitable for routine project management.

The object of the present invention is, solving the above problem, to provide a project simulation method and a project simulation system in which a probabilistic simulation can be performed by calculating an efficient allocation of resources, such as most suitable manpower and facilities, taking into consideration risk events, such as a delay, in plural projects.

### SUMMARY OF THE INVENTION

A project simulation method according to the present invention manages plural concurrent projects and simulates a period and profit of each project by using an information processor provided with input means, storage means, arithmetic means, and output means. The project simulation method includes the step of inputting a risk factor on an estimate of each project and a value of a resource including at least one of capital investment, such as equipment and facilities, and labor necessary in execution of each project by using the input means. The project simulation method further includes the step of calculating the following by using the arithmetic means, (i) a probability density function of a delay period of each project by using the risk factor and the value of the resource; (ii) production per unit time as to a period of each project including the delay period predicted based on the probability density function; (iii) probability density functions of the profit and a delay of each project by using a cost and the project period corresponding to the production and by changing the resource so as to minimize the delay period and excess of the cost of each project simultaneously among all the projects; and (iv) an expectation value as contingency reserve. The expectation value corresponds to a negative part of the profit in a probability density function of a total profit calculated from the profits of all the projects.

According to the method of the present invention, it is possible to solve the above-described problem by deriving an optimized solution of a resource allocation in the project portfolio and performing a simulation, with the use of an agent model which applies a game theory based on Econophysics. It is also possible to shorten the computation time by introducing a genetic algorithm.

According to the present invention, the simulation is performed with each project treated as an agent at the time before the project starts, for example, at the time of making an estimate, resulting in the probabilistic prediction of a period and cost of the project portfolio and the efficient resource allocation, incorporating risks such as a delay, to each project in a comparatively short time.

### BRIEF DESCRIPTION OF THE DRAWINGS

FIG. 1 is a flowchart of a project portfolio simulation method in accordance with an embodiment of the present invention;

FIG. 2 is a block diagram illustrating a hardware configuration of a project portfolio simulation system in accordance with the embodiment of the present invention;

FIG. 3 illustrates an example of a screen of the input items and buttons in the project portfolio simulation system in FIG. 2;

FIG. 4 is illustrates an example of a checklist of the project portfolio simulation system;

FIG. 5 is a flowchart illustrating a procedure of a genetic algorithm used in the embodiment;

FIG. 6 is a schematic diagram illustrating a concept of a gene in the genetic algorithm in FIG. 5;

FIG. 7 is a schematic diagram illustrating a concept of crossover in the genetic algorithm in FIG. 5;

FIG. 8 is a schematic diagram illustrating a concept of mutation in the genetic algorithm in FIG. 5;

FIG. 9 is a schematic diagram illustrating a concept of ranking of an objective function in the genetic algorithm in FIG. 5;

FIG. 10 is a schematic diagram illustrating a concept of the roulette method in the genetic algorithm in FIG. 5;

FIG. 11 is a graph illustrating a resource allocation result of labor (manpower);

FIG. 12 is a graph illustrating the resource allocation result of capital (facilities);

FIG. 13 is a graph illustrating probability density distribution of profit of one project; and

FIG. 14 is a graph illustrating probability density distribution of total profit of the project portfolio.

### DETAILED DESCRIPTION OF THE PREFERRED EMBODIMENT

With reference to the drawings, a project portfolio simulation method and system in accordance with an embodiment of the present invention is explained in detail.

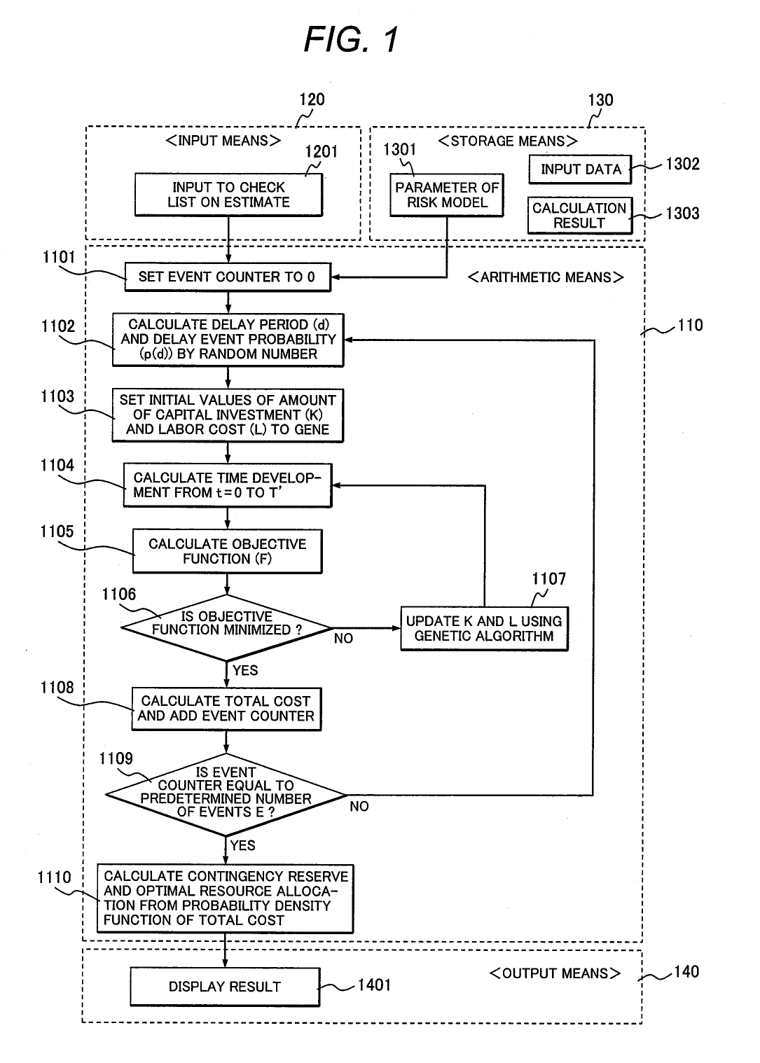

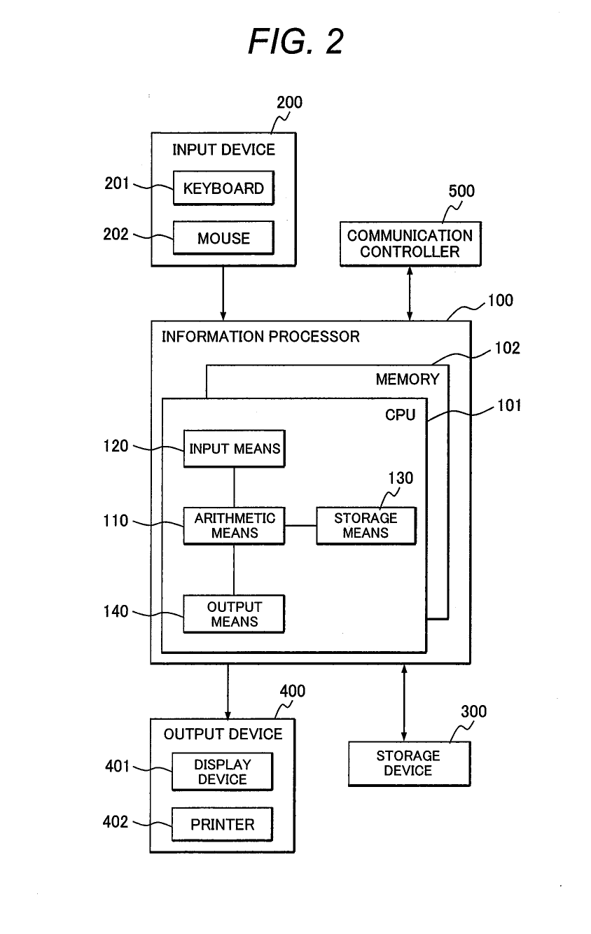

FIG. 1 is a flow chart illustrating the simulation method according to the present embodiment, and FIG. 2 is a block diagram illustrating a hardware configuration of the simulation system according to the present embodiment.

As illustrated in FIG. 2, the project portfolio simulation system includes an information processor 100, an input device 200, a storage device 300, an output device 400, and a communication controller 500 for communicating with another system via a network.

The information processor 100 possesses a central processing unit (CPU) 101, a memory 102, and an interface device (not shown). When the CPU 101 executes a simulation program on the memory 102, the information processor 100 functions as arithmetic means 110, input means 120, storage means 130, and output means 140. The information processor 100 sequentially performs, for example, execution of a simulation, control of data entry, storing, and output of a simulation result. The information processor 100 realizes a simulation system which, following the input of a checklist described later at the time before a project starts, for example at the time of making an estimate, performs the probabilistic prediction of a period and cost of a project portfolio and the efficient resource allocation to each project, incorporating risks such as a delay.

The input device 200 is equipment for inputting instructions and data to the information processor 100, and can be provided with a keyboard 201, a mouse 202, or a touch panel. In the present embodiment, the keyboard 201 and the mouse 202 are provided in FIG. 2. The input means 120 performs a process from the input device 200.

The storage device 300 is configured by a hard disk unit for example, and stores information in a readable and writable manner. The storage device 300 stores programs which are executed in the information processor 100, and data which is generated. Namely, the storage device 300 stores the programs which enable the CPU 101 and the memory 102 in the information processor 100 to function as the arithmetic means 110, the input means 120, the storage means 130, and the output means 140. One of the programs which the arithmetic means 110 executes includes the simulation program described above. The storage means 130 performs processes including control of reading/writing of data to the storage device 300, and control of reading/writing to the memory 102. The storage device 300 may be an external type or a built-in type.

The output device 400 is equipment for displaying information in a visible way, and can be provided with a display device, a printer, or etc. In the present embodiment, both the display device 401 and the printer 402 are provided in FIG. 2. A specific example of the display device 401 includes a liquid crystal display. A portable storage device for writing information as digital data can be also included in the output device 400. The portable storage device functions as an input device 200 when the information processor 100 reads data from the portable storage device. The output means 140 performs a process of data output to the output device 400. The output means 140 can perform both screen display and printout. The output means 140 also possesses a function to display an input screen corresponding to receiving process of data when the data is inputted in the input means 120. The input screen includes a button, for example, which is displayed on the screen for instructions described later.

The communication controller 500 performs data communication between the system and an external system, and controls the communication in transmitting and receiving information with the external system. The communication is controlled by the arithmetic means 110 in the information processor 100, for example.

As illustrated in FIG. 1, the arithmetic means 110 performs the following steps according to a program: reset of an event counter (Step 1101); generation of a delay period (d) by a random number and calculation of a delay event probability (p(d)) (Step 1102); setup of initial values of amount of capital investment (K) and a labor cost (L) to a gene (Step 1103); calculation of time development (derived from a production function) (Step 1104); calculation of an objective function (F) (Step 1105); determination of minimization of the objective function (Step 1106); calculation of the amount of capital investment (K) and the labor cost (L) using a genetic algorithm (Step 1107); calculation of the total cost and addition of the event counter (Step 1108); determination of whether the event counter is equal to the number of Monte Carlo events (E) (Step 1109); and calculation of the optimal resource allocation from the probability density function of the total cost (Step 1110). As described later, these processes are performed using a parameter 1301 of the delay risk model constructed in advance.

The simulation process by the project portfolio simulation system according to the present embodiment is explained.

First, the output means 140 displays a data input frame and a button on the display device 401 of the output device 400 in order to accept an input instruction to plural kinds of processes. When the data input frame and the button are specified by a cursor and selected by a click of a mouse on a screen, an activation instruction is accepted by the input means 120. A pull-down menu may be used for the data input.

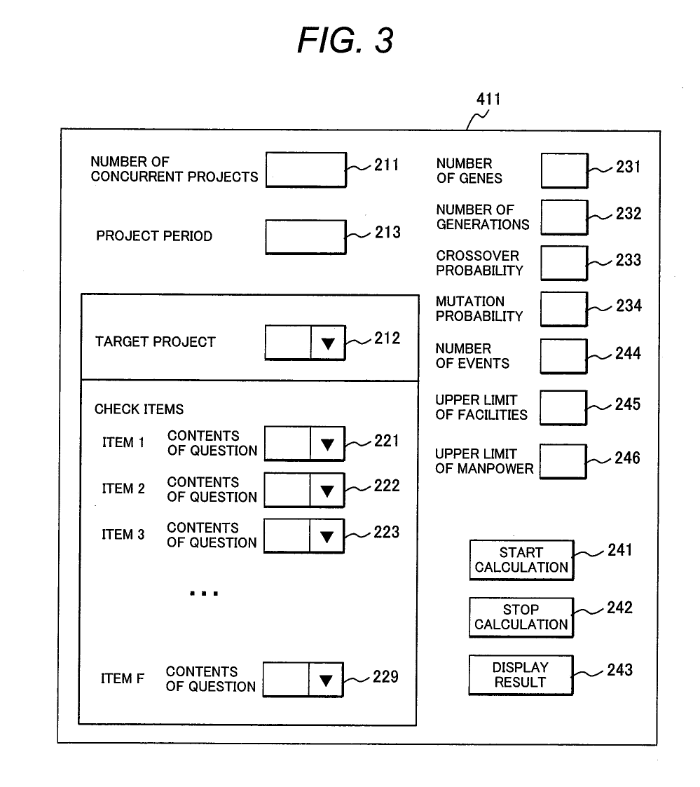

As the data input frames displayed on the display device 401 by the output means 140, items 211-234 illustrated in FIG. 3 are displayed, for example. In FIG. 3, the following items are prepared on the display screen 411: the number of concurrent projects (N) 211, a project period (T) 213, the number of genes (M) 231, the number of generations (S) 232, a crossover probability (Pc) 233, a mutation probability (Pm) 234, the number of Monte Carlo events (E) 244, a target project 212, question item 1 (221), question item 2 (222), question item 3 (223), and question item F 229. The question items are input items concerning a delay risk of a project in a checklist to be described below. The target project 212 is selected from N projects, and F question items are inputted. Data input frames are prepared for an upper limit Kmax of facilities 245 and an upper limit of manpower Lmax 246 as a total amount of resources available for carrying out the project portfolio.

The buttons are arranged at the lower right part of the display screen 411 in FIG. 3. Three buttons are illustrated in FIG. 3 as activation buttons, a start calculation button 241, a stop calculation button 242, and a display result button 243.

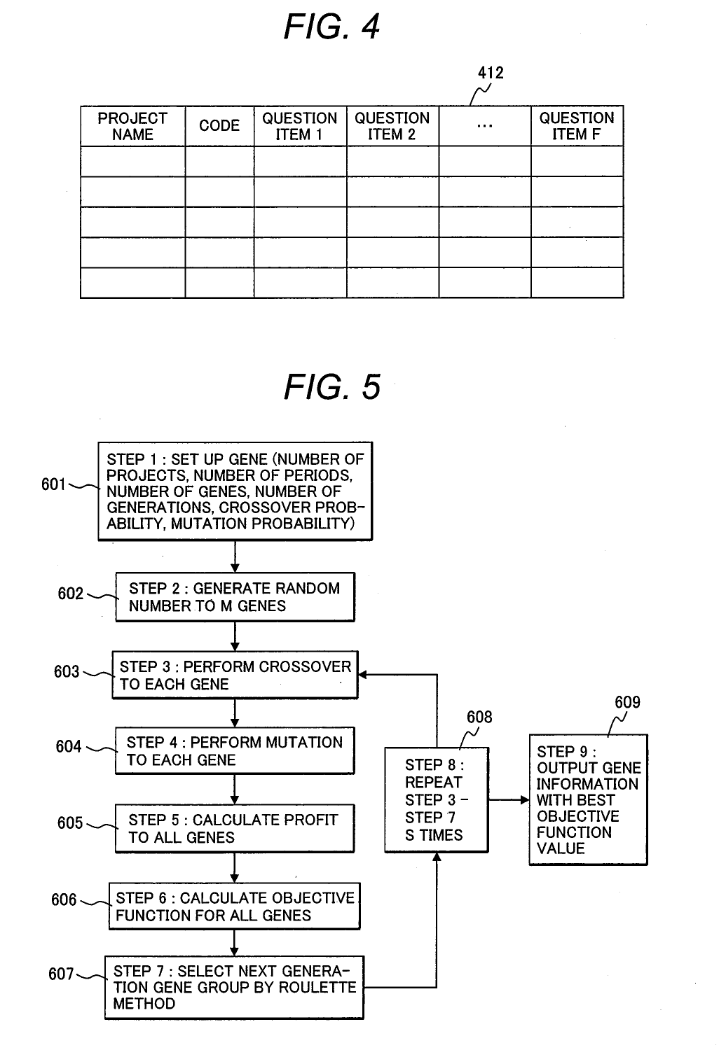

As a preparation for explaining each process, a delay risk model is explained. The delay risk model is constructed in advance by analysis of the checklist in the past project. The storage means 130 stores the parameter 1301 of the delay risk model in the memory 102 and the storage device 300. As an example, the delay risk model is constructed so that the items in the checklist of each project are inputted as risk factors (F pieces) and delay days (d) are obtained as an output as shown by Equation 1 below. The checklist includes items considered as the risk factors (F pieces) in the project in the form of a questionnaire as illustrated in FIG. 4. The checklist is generated based on the questionnaire result from the project manager of each project. Examples of such items include a business sector of the project, a management method for the delay period, a countermeasure for the delay, overall prospect of the project implementation (estimated number of processes).

d=f(risk factor 1, . . . , risk factor F)+σ_{d}ε (1)

In Equation 1, f(•) is an arbitrary function or an arbitrary form which describes the relationship between delay days d and risk factors; σ_{d} is an error of the multiple regression analysis described below; ands is a standard normal random number. The delay event probability in each project can be defined by Equation 2.

$$p ( d ) = \frac{number of projects generating delay d}{number of total project \times size of bin} \qquad ( 2 )$$

The selection method of the function f(•) is measured by calculating the correlation between the actual result of the past checklist in FIG. 4 and the actual result of the delay days.

In the concrete calculation method of the function f(•), multiple regression analysis by a round robin method is carried out for actual result data in the check items, for example. The multiple regression analysis by the round robin method is a technique of, regarding the risk factors as an explanatory variable, selecting F pieces of the risk factors which explain an explained variable best among the combination of all the risk factors. σ_{d} in Equation 1 is the error of the multiple regression analysis.

When the parameter of the delay risk model, which is measured as stated above, is stored in the storage device 300, it is possible to perform a benchmark test of the delay days by reading the stored parameter and using Equation 1 in the delay risk model. It is also possible to calculate the delay event probability by inputting the delay days d into Equation 2.

The input means 120 performs input process 1201 (FIG. 1) in which data is inputted into a checklist at the time of making an estimate. The input process 1201 is performed to an item among the check items in FIG. 4 which has become significant as a result of the round robin method in the delay risk model. The input process 1201 is performed by accepting the entry from the item 1 (221) to the item F (229) in FIG. 3 as the check items in the project. In addition, the input process 1201 is performed by accepting the entry of the number of concurrent projects 211, the target project 212, and the project period 213 in FIG. 3. The input process 1201 is performed to an item which is required in practicing the arithmetic means 110. Specifically, the input process 1201 is performed to the number of genes 231, the number of generations 232, the crossover probability 233, and the mutation probability 234 in FIG. 3. The input means 120 may also accept entries of other common basic data (not shown).

When the input process 1201 is performed, the arithmetic means 110 performs the processes in FIG. 1. The arithmetic means 110 is explained according to FIG. 1. Various kinds of data to be used for calculation are supplied by reading out the data which has been stored as input data 1302 in advance in the storage device 300 by the storage means 130. The input data 1302 is the stored numeric value which has been inputted in item 1 to item F (221-229), as illustrated in the left side of FIG. 3. The input data 1302 may be accepted by the input means 120 through the communication controller 500, if desired. The parameter of the delay risk model is stored in the storage device 300 as the parameter 1301 of the delay risk model.

In FIG. 1, the arithmetic means 110 sets the event counter to 0 (Step 1101).

At Step 1102, according to the delay risk model (Equation 1) and Equation 2, the delay period (d) and the delay event probability (p(d)) are calculated, using the parameter 1301 of the delay risk model, the input parameter of the checklist inputted by the input process 1201 at the time of making the estimate, and the random number ε. Note that the delay period (d) and the delay event probability (p(d)) take different values for every event.

Order volume of each target project is denoted by W and scheduled project period is denoted by T. The production ( Y̅) per unit time in money equivalent is defined as Equation 3. The order volume W is quantity of work in money equivalent.

$$\overline{Y} = \frac{1}{T} {\int }_{0}^{T} Y ( t ) d t = W / T \qquad ( 3 )$$

Amount of the capital investment per unit time ( K̅) and the labor cost per unit time ( L̅) are defined as Equation 4 and Equation 5, respectively.

$$\overline{K} = \frac{1}{T} {\int }_{0}^{T} K ( t ) d t \qquad ( 4 )$$

$$\overline{L} = \frac{1}{T} {\int }_{0}^{T} L ( t ) d t \qquad ( 5 )$$

Since the following Equation 6 is satisfied by Equation 3, the following Equation 7 holds at arbitrary time t in the project period.

$$\begin{matrix}{\int }_{0}^{T} Y ( t ) d t = W & ( 6 ) \\ {\int }_{0}^{t} Y ( {t}^{′} ) d {t}^{′} = w ( t ) & ( 7 )\end{matrix}$$

When the project advances as planned without delay in progress, the following Equation 8 holds at the scheduled project period T.

w(T)=W (8)

At Step 1102 at which the delay period (d) and the delay event probability (p(d)) are calculated, when a delay arises, the quantity of work W′ in consideration of the delay period d is given by Equation 9.

$${W}^{′} = W + \frac{W}{T} d \qquad ( 9 )$$

A project period T′ including the delay period d is given by Equation 10. Note that the project period T′ including the delay period d is equal to a period which is necessary for processing the quantity of work W′ in consideration of delay period d after supplying the amount of capital investment per unit time ( K̅) and the labor cost per unit time ( L̅).

w(T′)=W′ (10)

At Step 1103, in calculating time development, initial values are set up as in the following Equation 11-Equation 13. A superscript “(G)” means inputs of capital investment K and labor cost L required for minimizing the objective function F described later.

Y(0)= Y̅ (11)

K^{(G)}(0)= K̅ (12)

L^{(G)}(0)= L̅ (13)

Equation 14 is defined as a production function of the project. A, α, and β are parameters and δ is an error term of the production function.

Y̅=A K̅^{α} L̅^{β}δ (14)

Logarithmic transformation of both sides of Equation 14 will yield Equation 15.

log₁₀ Y̅=log₁₀A+α log₁₀ K̅+β log₁₀ L̅+ε (15)

Here, it is assumed that ε satisfies the following Equation 16 and Equation 17.

ε=log₁₀δ (16)

ε=N(0,σ²) (17)

Equation 15 makes it possible to calculate each parameter from the past project record, using multiple regression analysis etc.

In Equation 14, division of each item at time t+1 by each item at time t will define the following Equation 18.

$$\frac{Y ( t + 1 )}{Y ( t )} = {( \frac{K ( t + 1 )}{K ( t )} )}^{α} {( \frac{L ( t + 1 )}{L ( t )} )}^{β} ( \frac{δ ( t + 1 )}{δ ( t )} ) \qquad ( 18 )$$

Logarithmic transformation of both sides of Equation 18 will yield Equation 19.

$${log}_{10} \frac{Y ( t + 1 )}{Y ( t )} = α {log}_{10} ( \frac{K ( t + 1 )}{K ( t )} ) + β {log}_{10} ( \frac{L ( t + 1 )}{L ( t )} ) + {log}_{10} ( \frac{δ ( t + 1 )}{δ ( t )} ) \qquad ( 19 )$$

The growth rate x(t) of the production Y(t) is defined as Equation 20.

$$x ( t ) = {log}_{10} \frac{Y ( t )}{Y ( t - 1 )} \qquad ( 20 )$$

Rewriting of Equation 19 using Equation 20 yields the following Equation 21 which describes the time development of the growth rate x(t). Equation 21 is a discretized stochastic differential equation and is a fundamental equation which describes the activity of the project agent in the present invention.

$$x ( t + 1 ) = α {log}_{10} ( \frac{{K}^{( G )} ( t + 1 )}{{K}^{( G )} ( t )} ) + β {log}_{10} ( \frac{{L}^{( G )} ( t + 1 )}{{L}^{( G )} ( t )} ) + ɛ ( t + 1 ) - ɛ ( t ) \qquad ( 21 )$$

Here, the following assumption is made.

ε(t+1)−ε(t)=\sqrt{2}N(0,σ²) (22)

Further, the growth rate k(t) of the amount of capital investment K(t) and the growth rate l(t) of the labor cost L(t) are respectively defined as follows.

$$\begin{matrix}k ( t ) = {log}_{10} \frac{K ( t )}{K ( t - 1 )} & ( 23 ) \\ l ( t ) = {log}_{10} \frac{L ( t )}{L ( t - 1 )} & ( 24 )\end{matrix}$$

At Step 1104, time development of the growth rate x(t) from t=0 to T′ is calculated according to Equation 21. Then, according to Equation 20, the production Y(t) is calculated from the growth rate x(t). At this time, a period T^{(G)} necessary for completing the quantity of work W′ can be calculated in an analogous form to Equation 10 as follows.

w(T^{(G)})=W′ (25)

Since more resources than the amount of capital investment K(0) and the labor cost L(0), which have been supplied at the start time of the project, are supplied in order to complete the quantity of work W′, the following relation holds in general.

T^{(G)}<T′ (26)

At Step 1105, the objective function is calculated. The objective function is configured from a delay period (T^{(G)}−T), a material cost C, the amount of capital investment K, the labor cost L, and a usage rate of equipment r. Specifically, the following Equation 27 is set as the objective function F. In the Equation 27, a coefficient B is a weight which determines the degree of contribution of the first term and the second term.

$$F = B ( \vert {T}^{( G )} - T \vert ) + {\int }_{0}^{{T}^{′}} ( C ( t ) + {rK}^{( G )} ( t ) + {L}^{( G )} ( t ) ) d t \qquad ( 27 )$$

In Equation 27, if the amount of capital investment K and the labor cost L are made small, the project period T′, becomes longer than the scheduled project period T by the delay days d, increasing the value of the first term (delay period) and decreasing the value of the second term (total cost). On the other hand, if the amount of capital investment K and the labor cost L are made large, the first term (delay period) takes a small value and the second term (total cost) takes a large value. Therefore, the optimum values of the amount of capital investment K and the labor cost L are determined by the allocation of the amount of capital investment K and the labor cost L which minimizes the objective function F. Such an allocation of the amount of capital investment K and the labor cost L is what a project manager actually performs on routine work. In this meaning, it is considered that the model of the present invention simulates the behavior of the project manager. One manager is assigned to each project, and each manager demand the amount of capital investment K and the labor cost L which minimize the objective function F of the own project, competing with other managers who demand their own amount of capital investment K and labor cost L. Accordingly, since the optimized solution is determined among the project portfolios, the optimized solution can be regarded as a Nash equilibrium in the game theory.

Now, minimization of the objective function by the genetic algorithm at Step 1106 and Step 1107 is explained. The optimizing calculation stated above requires a considerable number of memories and a considerable amount of computation time if the number of projects is large and the period is long, because the number of the calculation times increases exponentially with the combination. In the present invention, an approximate Nash equilibrium is searched for through the genetic algorithm proposed below. By this method, it is possible to search for a Nash solution efficiently with a small number of memories and a small amount of computation time.

The genetic algorithm is a heuristic technique of optimizing and includes nine steps illustrated in FIG. 5.

At Step 1 in FIG. 5, the number of agents (the number of projects) N, the number of periods T, the number of genes M (an arbitrary number which is set for optimization), the number of generations L, the crossover probability Pc, and the mutation probability Pm are inputted to set up a gene. This entry is performed by the input means 120 through the data input frames on the display screen 411 in FIG. 3, where the number of concurrent projects 211, the project period 213, the number of genes 231, the number of generations 232, the crossover probability 233, and the mutation probability 234 are shown as the data input frames. The crossover probability Pc may be set to 0.8 and the mutation probability Pm may be set to an inverse number of the gene length.

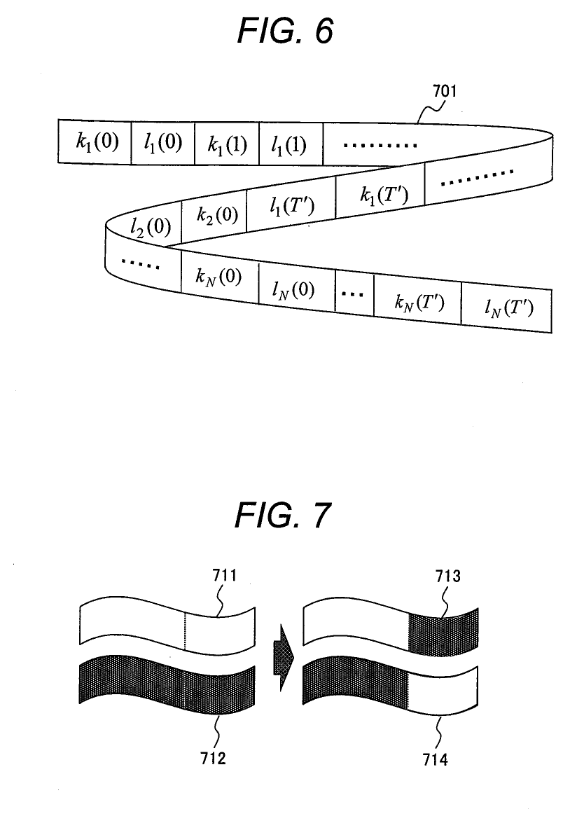

A gene has an image of a long tape as illustrated in FIG. 6. In each site (a divided section on the tape) of a gene, the growth rate of the amount of capital investment k(t) and the growth rate of the labor cost l(t) are written in the binary number system as a strategy of each agent. Here, t=1−T′. As an example, the growth rate of the amount of capital investment K and the growth rate of the labor cost L are assumed to be in the range of 0.5-2. Since log₁₀ 0.5=−0.3 and log₁₀ 2.0=0.3, the range of the logarithmic growth rate is −0.3 to 0.3. For a four-bit gene, “1111” (binary number system) is equal to “15” (decimal number system). Accordingly, 16 steps can be expressed with four bits. Since 0.6/(16−1)=0.04, the logarithmic growth rate takes discrete values such as −0.3, −0.26, . . . , 0.26, and 0.3.

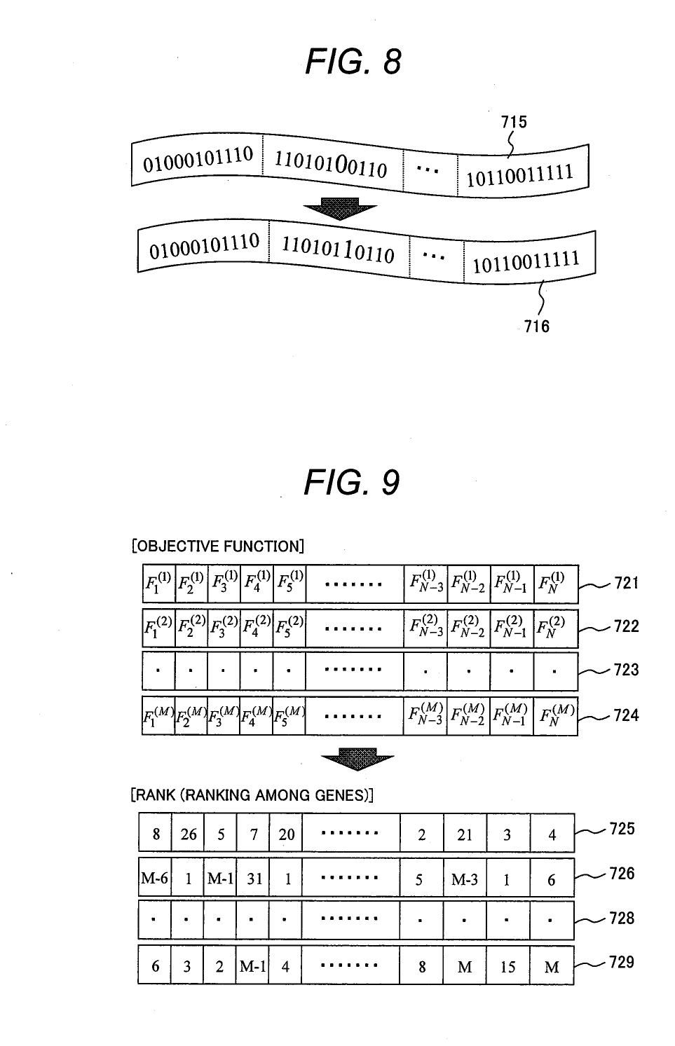

At Step 2, a random number is generated to M genes and either 1 or 0 is written in each site as an initial value. At Step 3, using the crossover probability Pc for each gene, two genes are cut and crossed (recombined) at a random position as shown in FIG. 7. At Step 4, for each site of the gene, 0 is inverted to 1 or 1 is inverted to 0 using the mutation probability Pm as shown in FIG. 8. This procedure is called mutation. At Step 5, for the j-th gene of M genes, the growth rate of the amount of capital investment k(t) and the growth rate of the labor cost l(t) in the period 0 to T′ of the i-th agent are converted from the binary notation into the decimal notation, and the amount of capital investment K(t) and the labor cost L(t) are calculated. However, in a case where the total value of the amount of capital investment K(t) exceeds the upper limit Kmax of the amount of capital investment as shown in Equation 28, substitution in Equation 29 is made.

$$\begin{matrix}{\sum }_{i} {K}_{i}^{( G )} ( t ) > {K}_{ma x } & ( 28 ) \\ {K}_{i}^{( G )} ( t ) ← \frac{{K}_{ma x}}{{\sum }_{i} {K}_{i}^{( G )} ( t )} {K}_{i}^{( G )} ( t ) & ( 29 )\end{matrix}$$

Similarly, in a case where the total value of the labor cost L(t) exceeds the upper limit Lmax of the labor cost as shown in Equation 30, substitution in Equation 31 is made.

$$\begin{matrix}{\sum }_{i} {L}_{i}^{( G )} ( t ) > {L}_{ma x} & ( 30 ) \\ {L}_{i}^{( G )} ( t ) ← \frac{{L}_{ma x}}{{\sum }_{i} {L}_{i}^{( G )} ( t )} {L}_{i}^{( G )} ( t ) & ( 31 )\end{matrix}$$

The objective function Fᵢ^{(j)} is calculated using the amount of capital investment K(t) and the labor cost L(t) which have been calculated in the procedure described above. The objective function is calculated for all the agents (i=1, . . . , N) and all the genes (j=1, . . . , M).

At Step 6, the objective function is calculated for each of M genes. As shown in FIG. 9, for the objective function Fᵢ^{(j)} calculated for each agent, ranking of each site among the genes is given. The sum total of the ranking of each site is obtained for every gene, and the sum total of the ranking is defined as an objective function value. When the ranking of all the sites of a certain gene is the first place, the objective function value is equal to 1/N and the maximum. At this time, since the strategy of all the agents is optimal, the objective function value is the strict solution to the Nash equilibrium.

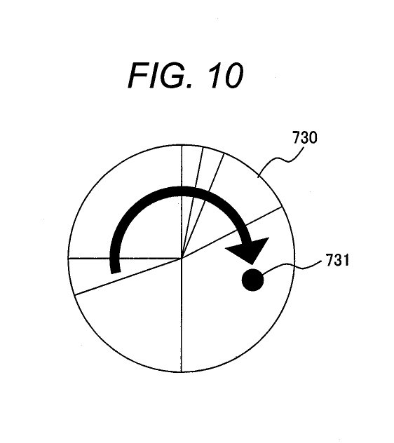

At Step 7, M genes with a high objective function value calculated above are selected, allowing the duplication. Specifically, the so-called roulette method is employed for the selection. A roulette wheel 730 is set up to have plural sections on it as illustrated in FIG. 10. The area of each section is assigned proportional to an objective function value of each gene. Then the roulette wheel 730 is turned around, and the gene at a place where the ball 731 stopped will be selected. Accordingly, it is possible to select a combination of M genes with comparatively high objective function values as a group of genes of a new generation.

At Step 8, the operations from Step 3 to Step 7 are repeated S times.

At Step 9, gene information with the best objective function value selected by the above process is outputted. The solution with the best objective function value is an approximate solution of the Nash equilibrium.

Returning to FIG. 1, at Step 1108, the total cost and the objective function F are calculated by substituting the optimized solutions of the capital K^{(G)}(t) and the labor L^{(G)}(t) calculated at Step 1107 into Equation 27. The number of the calculation of the total cost and the objective function F is added to the event counter.

At Step 1109, the procedures from Step 1102 to Step 1108 are executed repeatedly with the event counter, which indicates the number of times of execution, incremented per every execution until the event counter reaches a predetermined number of times (E times) which is set up arbitrarily.

At Step 1110, the probability density function is measured with respect to the equilibrium solution (capital K and labor L) calculated from Step 1102 to Step 1109, and the optimal resource allocation and the contingency reserve are measured.

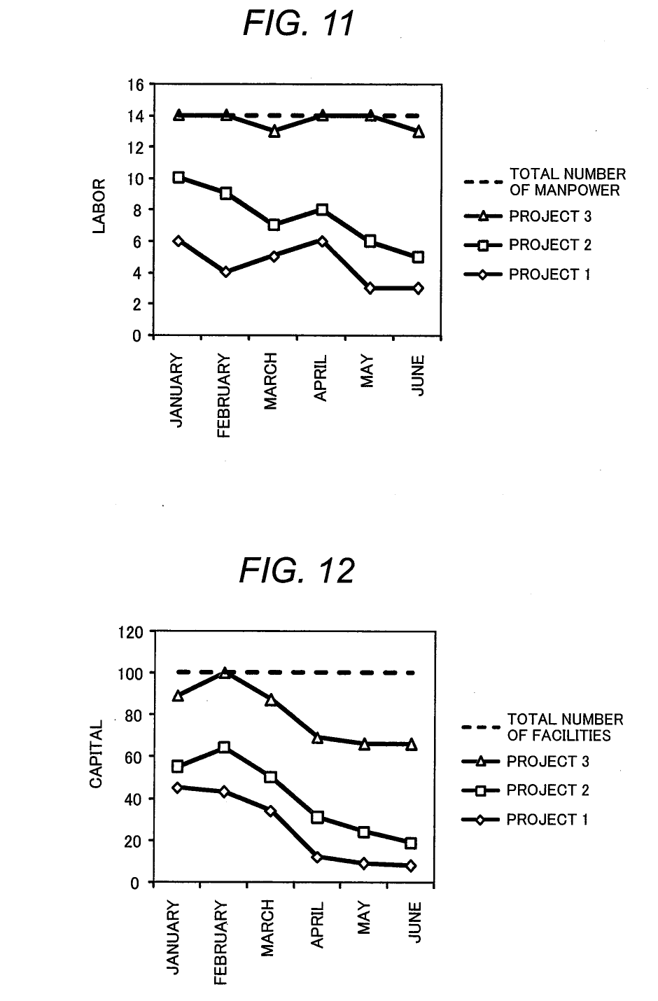

In the simulation system according to the present embodiment, when the input means 120 accepts operation of pushing the display result button 243 illustrated in FIG. 3, the output means 140 displays the optimal resource allocation with respect to the equilibrium solution (capital K and labor L) calculated by the arithmetic means 110, on the display device 401, such as a liquid crystal display. Examples of the outputs on the display device 401 are illustrated from FIG. 11 to FIG. 14. The printer 402 can print the charts of the outputs.

FIG. 11 shows a resource allocation result of the labor (manpower). A dotted line in the figure indicates the total number of manpower. The number of manpower who works in the entire project portfolio composed by three projects cannot surpass the total number of manpower. In the example shown in FIG. 11, though one surplus person appears in March and June, all the manpower has been assigned to each project in the other months.

FIG. 12 shows a resource allocation result of the capital (facilities). A dotted line in the figure indicates the total number of facilities. The number of facilities used by the entire project portfolio composed by three projects cannot surpass the total number of facilities. In the example shown in FIG. 12, though all the facilities are used in February, surplus facilities have arisen in the other months.

Profit Pᵢ of the i-th project included in the project portfolio is defined as Equation 32.

$${P}_{i} = {W}_{i} - {\int }_{0}^{{T}_{i}^{′}} ( {C}_{i} ( t ) + {r}_{i} {K}_{i}^{( G )} ( t ) + {L}_{i}^{( G )} ( t ) ) d t \qquad ( 32 )$$

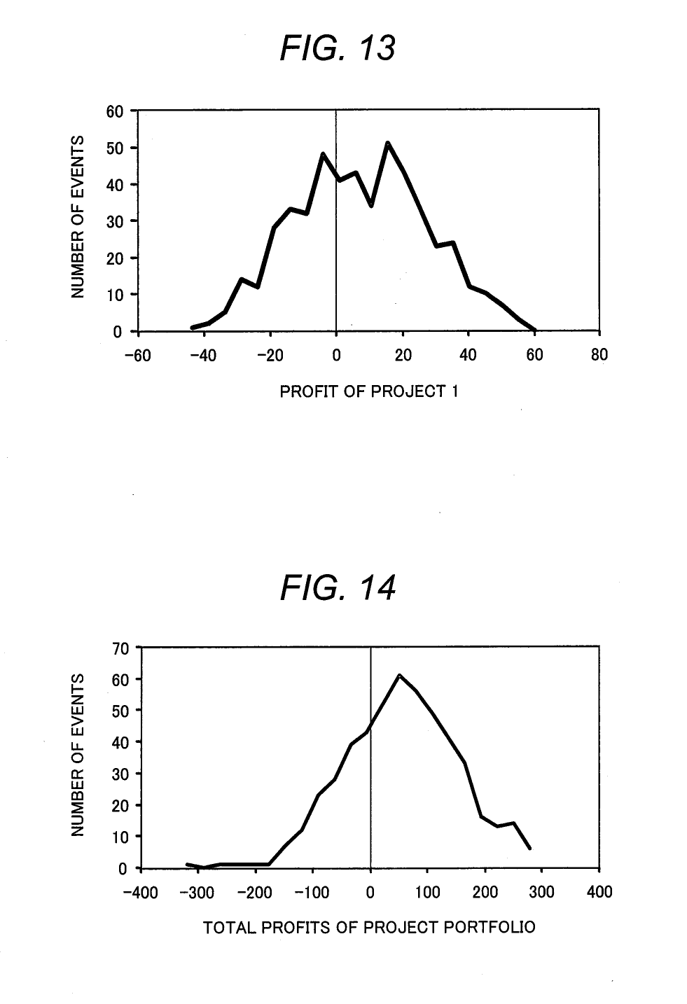

FIG. 13 shows a probability density distribution of the profit Pᵢ of the i-th project (project 1 in the FIG. 13) included in the project portfolio. A mean value of the negative part of the profit is −14.212. Accordingly, from a viewpoint of the project management, it is desirable to prepare as much as 14.212 as the contingency reserve of the project. The contingency reserve may denote a reserve fund for one project. The total profit P of the project portfolio is defined as Equation 33.

$$P = {\sum }_{i = 1}^{N} {P}_{i} \qquad ( 33 )$$

FIG. 14 shows a probability density distribution of the total profit P of the project portfolio. A mean value of the negative part of the profit is −59.822. Accordingly, from a viewpoint of the project management, it is desirable to prepare as much as 59.822 as the contingency reserve of the entire project portfolio. The contingency reserve with respect to the entire project portfolio may be called management reserve.

According to the simulation method of the present embodiment, the simulation is performed with each project treated as an agent at the time before the project starts, for example, at the time of making an estimate. As a result, a period and cost of the project portfolio can be predicted in a probabilistic manner, and an efficient resource allocation to each project can be performed for a comparatively short time, incorporating risks such as a delay.

In the present embodiment, the most suitable resource allocation and contingency reserve are calculated using the genetic algorithm. Accordingly, it is possible to perform calculation with a small amount of memory area and a small amount of computation time, making the present simulation method applicable to a simulation with a large number of projects and a long period.

The present invention is not restricted to the embodiment described above, and various modifications, combinations, and alterations may occur depending on design requirements and other factors insofar as they are within the scope of the appended claims or the equivalents thereof.

What is claimed is:

1. A project simulation method for managing a plurality of concurrent projects and simulating a period and profit of each project by using an information processor provided with input means, storage means, arithmetic means, and output means, the project simulation method comprising:
inputting a risk factor on an estimate of each project and a value of a resource including at least one of capital investment and labor necessary in execution of each project by using the input means; and
calculating the following by using the arithmetic means,
(i) a probability density function of a delay period of each project by using the risk factor and the value of the resource,
(ii) production per unit time as to a period of each project including the delay period predicted based on the probability density function,
(iii) probability density functions of the profit and a delay of each project by using a cost and the project period corresponding to the production and by changing the resource so as to minimize the delay period and excess of the cost of each project simultaneously among all the projects, and
(iv) an expectation value as contingency reserve, the expectation value corresponding to a negative part of the profit in a probability density function of a total profit calculated from the profits of all the projects.

2. The project simulation method according to claim 1,
wherein the risk factor is a numerical value indicating a feature of the project including a business field or the number of estimated processes on the estimate of each project; and an upper limit of the value of the resource is inputted when inputting the risk factor and the value of the resource by using the input means.

3. The project simulation method according to claim 1,
wherein, in the calculation of the production per unit time at the above-mentioned step (ii), a growth rate of the production is calculated and then the production per unit time is calculated from the growth rate, the growth rate indicating a time change of the production per unit time.

4. The project simulation method according to claim 1,
wherein the output means displays for each project, the probability density function of the profit, a resource allocation result, the probability density function of the delay when the resource is allocated, and the contingency reserve.

5. The project simulation method according to claim 1,
wherein, in the calculation of the probability density functions of the profit and the delay at the above-mentioned step (iii), the number of projects and a project period are set as a gene, and a genetic algorithm is utilized for the calculation of the step (iii).

6. A project simulation system for managing a plurality of concurrent projects and simulating a period and profit of each project, the project simulation system comprising:
input means for inputting a risk factor on an estimate of each project and a value of a resource including at least one of capital investment and labor necessary in execution of each project; and
arithmetic means for calculating the following,
(i) a probability density function of a delay period of each project by using the risk factor and the value of the resource,
(ii) production per unit time as to a period of each project including the delay period predicted based on the probability density function,
(iii) probability density functions of the profit and a delay of each project by using a cost and the project period corresponding to the production and by changing the resource so as to minimize the delay period and excess of the cost of each project simultaneously among all the projects, and
(iv) an expectation value as contingency reserve, the expectation value corresponding to a negative part of the profit in a probability density function of a total profit calculated from the profits of all the projects.

7. The project simulation system according to claim 6,
wherein the risk factor is a numerical value indicating a feature of the project including a business field or the number of estimated processes on the estimate of the project; and an upper limit of the value of the resource is inputted when inputting the risk factor and the value of the resource by using the input means.

8. The project simulation system according to claim 6,
wherein, in the calculation of the production per unit time at the above-mentioned step (ii), the arithmetic means calculates a growth rate of the production and then calculates the production per unit time from the growth rate, the growth rate indicating a time change of the production per unit time.

9. The project simulation system according to claim 6, further comprising output means
wherein the output means displays for each project, the probability density function of the profit, a resource allocation result, the probability density function of the delay when the resource is allocated, and the contingency reserve.

10. The project simulation system according to claim 6,
wherein, in the calculation of the probability density functions of the profit and the delay at the above-mentioned step (iii), the arithmetic means sets the number of projects and a project period as a gene and utilizes a genetic algorithm for the calculation of the step (iii).
